(19) United States
(12) Patent Application Publication
(10) Pub. No.: US 2025/0079771 A1
(43) Pub. Date: Mar. 6, 2025

(54) ELECTRICAL CONNECTOR WITH AN IMPROVED SHELL

(71) Applicants: FUDING PRECISION INDUSTRY (ZHENGZHOU) CO.,LTD., Zhengzhou (CN); FOXCONN INTERCONNECT TECHNOLOGY LIMITED, Grand Cayman (KY)

(72) Inventors: XIN-LI WANG, Zhengzhou (CN); YU-KE CHEN, Kunshan (CN)

(21) Appl. No.: 18/820,288

(22) Filed: Aug. 30, 2024

(30) Foreign Application Priority Data
Aug. 30, 2023 (CN) 202311103332.8

(51) Int. Cl. H01R 13/6595; H01R 12/51; H01R 13/50

(52) U.S. Cl. CPC H01R 13/6595; H01R 12/51; H01R 13/50

(57) ABSTRACT

An electrical connector includes: an insulating housing comprising a base portion and a tongue portion; plural terminals located at the tongue portion; and an outer shell surrounding the insulating housing and comprising a first shell and a second shell discrete from each other, the first shell comprises an upper plate, two first side plates, and a rear plate spaced from the two first side plates, the second shell comprises a lower plate and two second side plates, the first shell and the second shell are assembled together to commonly surround the insulating housing for defining a mating cavity around the tongue portion, the upper plate and the lower plate are parallel to the tongue portion and located at two opposite sides of the tongue portion, and each of the second side plates spans forward to reach a corresponding first side plate and spans backward to reach the rear plate.

### BACKGROUND OF THE INVENTION

### Field of the Invention

The present invention relates to an electrical connector with an improved shell.

### Description of Related Arts

China Patent No. 214625443U discloses a right-angled electrical connector which comprises an insulating housing, plural terminals retained in the insulating housing, and a metal shell surrounding the insulating housing. The metal shell is integrally formed and comprises an upper portion, a lower portion, two side portions, and a rear portion. As the metal shell is cuboid with only one opening, it is hard for assembling the insulating housing with terminals into the metal shell.

Therefore, it is necessary to provide an electrical connector with an improved shell.

### SUMMARY OF THE INVENTION

The object of the present invention is to provide an electrical connector with an improved shell.

To achieve the above object, an electrical connector comprises: an insulating housing comprising a base portion and a tongue portion extending forward from the base portion; plural terminals located at the tongue portion; and an outer shell surrounding the insulating housing and comprising a first shell and a second shell discrete from each other, wherein the first shell comprises an upper plate, two first side plates, and a rear plate spaced from the two first side plates, the second shell comprises a lower plate and two second side plates, the first shell and the second shell are assembled together to commonly surround the insulating housing for defining a mating cavity around the tongue portion, the upper plate and the lower plate are parallel to the tongue portion and located at two opposite sides of the tongue portion, and each of the second side plates spans forward to reach a corresponding first side plate and spans backward to reach the rear plate.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector;

FIG. 2 is an exploded perspective view of the electrical connector of FIG. 1;

FIG. 3 is another exploded perspective view of the electrical connector of FIG. 1;

FIG. 4 is a cross-sectional view of the electrical connector along line A-A in FIG. 1;

FIG. 5 is a perspective view of a mating connector;

FIG. 6 is an exploded perspective view of the mating connector of FIG. 5;

FIG. 7 is a cross-sectional view of the mating connector along line B-B in FIG. 5; and

FIG. 8 is a cross-sectional view of the mated electrical connector and the mating connector.

### DETAILED DESCRIPTION OF THE PREFERRED EMBODIMENT

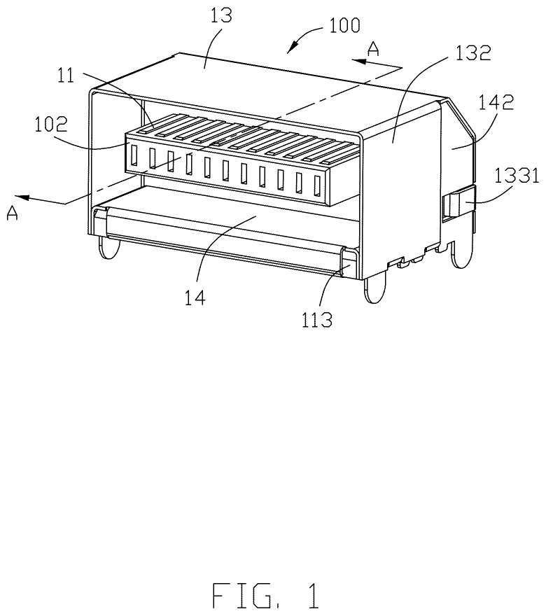

Referring to FIGS. 1, 5, and 8, an electrical connector assembly comprises an electrical connector 100 in a type of a right angled male connector adapted for mounting on a first circuit board (not shown) and a mating connector 200 in a type of a female connector adapted for mounting on a second circuit board (not shown). Signals are able to be transmitted between the first circuit board and the second circuit board when electrical connector 100 and the mating connector 200 are mated with each other.

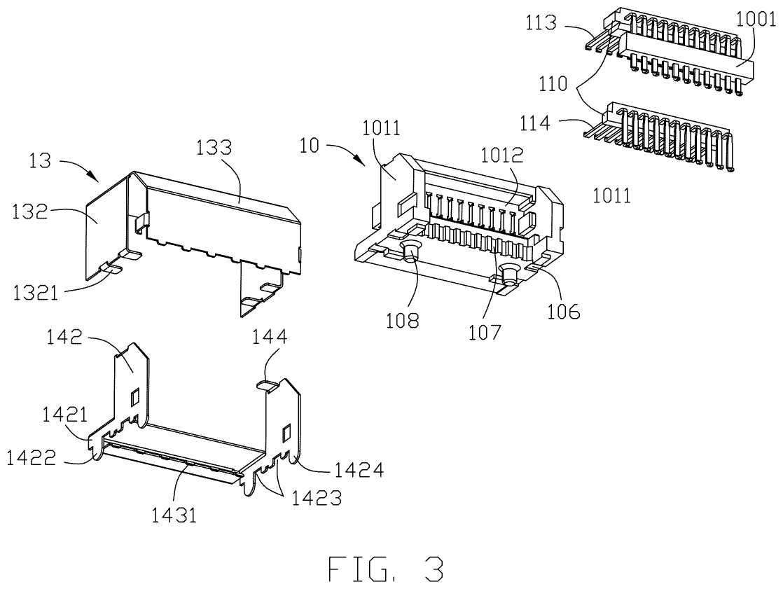

Referring to FIGS. 1-3, the electrical connector 100 comprises an insulating housing 10, plural terminals 11 and an outer shell 12 surrounding the insulating housing 10. The insulating housing 10 has a base portion 101 and a tongue portion 102 extending forward from the base portion 101. The terminals 11 are rowed on two opposite faces of the tongue portion 102. Each terminal 11 comprises a fixing portion, a plate portion 111 extending forward from the fixing portion and exposed on the face of the tongue portion 102 and a tail portion 112 extending backward and downward from the fixing portion. In this embodiment, the fixing portions of the terminals 11 are located in the base portion 101, the plat portions extend through the base portion 101 and are exposed on two opposite faces of the tongue portions, and the tail portions of the terminals 11 bend downward and are exposed behind the base portion 101.

The outer shell 12 comprises a first shell 13 and a second shell 14. The first shell 13 has two first side plates 132, an upper portion (upper plate) 131 between the two first side plates 132 and a rear plate 133 extending backward and downward from the upper plate 131. The two first side plates 132, the upper plate 131 and the rear plate 133 are integrally formed by a same metal plate. The second shell 14 comprises a plate-like lower portion (lower plate) 141 and two second plate-like side plates 142, and the lower portion 141 and the second side plates 142 are integrally formed by a same metal plate. The upper plate 131 and the lower plate 141 are parallel to the tongue portion 102 and are located at the two sides of the tongue portion 102 in an upper-down direction respectively. Each second side plate 142 extends forward to reach the first side plate 132 and extends backward to reach/resist against the rear plate 133, thus, the first shell 13 and the second shell 14 cooperatively surround the insulating housing 10 perfectly and form a mating cavity in which the tongue portion 102 extends. The electrical connector 100 has a good shielding performance as the outer shell 12 formed by the first shell 13 and the second shell 14 not only shields an upper side and the lower side of the insulating housing 10 in which the terminals 11 are retained but also shields a left side, a right side, and a rear side of the insulating housing 10. As both of the first shell 13 consisting of the upper plate, two first side plates and a rear plate, and the second shell 14 consisting of the lower plate 141, two second side plates 142 are half shells, it is easier for assembling the insulating housing 10 into the first shell 13 and the second shell 14 than into a one-piece outer shell.

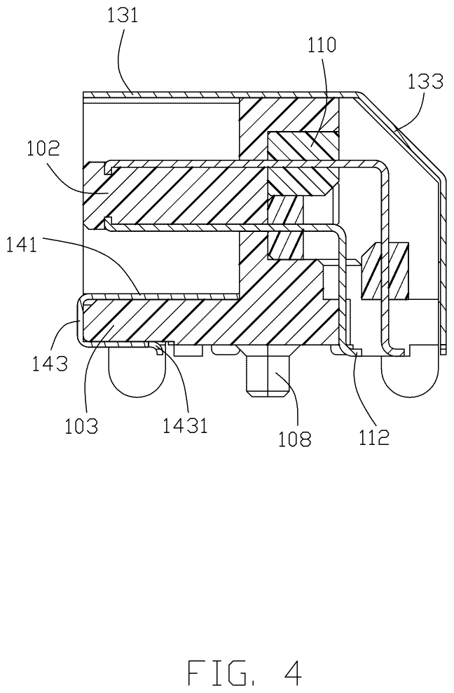

Referring to FIGS. 1-2 and 4, the terminals 11 comprises a first row of terminals 113 located at the upper face of the tongue portion 102 and a second row of terminals 114 located at the lower face of the tongue portion 102. The base portion 101 comprises two side walls 1011 and a receiving cavity 1012 opening backward at a rear end thereof, the first row of terminals 113 are injection molded in a first insulating bar 110 to form a first insulating module 11a, and the second row of terminals 114 are injection molded into another first insulating bar 110 to form a second terminal module 11b. The fixing portion and the plate portion 111 are in a same horizontal plane, the plate portion 111 is in front of the first insulating bar 110 and the tail portion is behind the first insulating bar 110 and bend downwardly with an approximately 90 degrees relative to the fixing portion. The first insulating bars 110 of the first terminal module 11a and the second terminal module 11b are received and retained in the receiving cavity 1012 and the tail portions of the first terminal module 11a are behind the tail portions of the second terminal module 11b. After the first terminal module 11a and the second terminal module 11b are formed, the insulating housing 10 is injection molded outside the first terminal module 11a and the second terminal module 11b, meanwhile, the tail portions 112 of the first row of terminals are injection molded with a second insulating bar 1001 for further fixing of the tail portions 112 of the first row of terminals 113. The insulating housing 10 has plural fixing grooves 107 in which the tail portions 112 of the second row of terminals 114 are received respectively for further fixing of the second row of terminals 114.

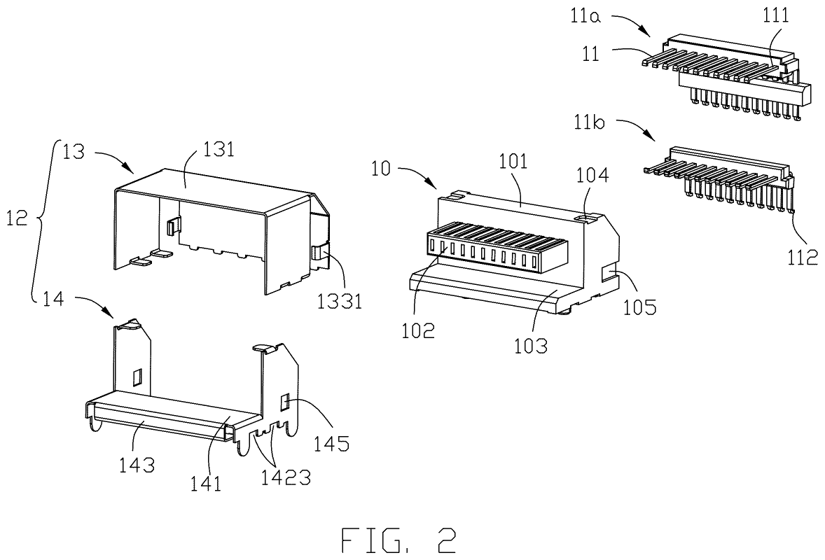

Referring to FIGS. 2-4, the insulating housing 10 further comprises a board portion 103 which extends forward from the base portion and is below the tongue portion 102. The lower plate 141 is attached to and covers an upper face of the board portion 103. The second shell 14 further comprises an attachment plate 143 and two front side plates 1421, the attachment plate 143 bends from a front end of the lower plate 141 and toward a bottom of the board portion 103 for making the lower plate 141 firmly attached to the board portion 103. The front side plate 1421 bend from two sides of the lower portion 141 downward, the second side plate 142 is behind the board portion, and the front side plate is in a same plane with corresponding second side plate 142. Each of the two second side plates 142 has a first locking tab 144 and an upper face of the base portion 101 has two first locking grooves 104 in which the first locking tabs 144 are received.

Referring to FIGS. 1-3, in this embodiment, the first side plate 132 is located outside the corresponding second side plate 142 and the front side plate 1421 after the first shell 13 and the second shell 14 are assembled to the insulating housing 10. For firmly fixing the first shell 13 to the insulating housing 10, the side walls 1011 has two second locking grooves 105 opening backward, the second side plate 142 has two through openings 145 facing the second locking grooves 105. The rear plate 133 has two second locking tabs 1331 bending forward from two side edges thereof. The two second locking tabs 1331 pass through the through openings 145 and are received in the second locking grooves 105. To prevent a leakage of the signal, a diagonal line of the opening 145 is less than 2 mm. In order to fix the first shell 13 to the insulating housing 10 in an upper-down direction, a lower face of the insulating housing 10 has two third locking grooves 106 near one side edge thereof. Each first side plate 132 has two third locking tabs 1321 bending from a lower edge thereof and received in the third locking grooves 106. Both lower edges of the second side plate 142 and the front side plate 1421 have a notch 1423, the third locking tabs 1321 go through the notches 1423 and are received in the third locking grooves 106. The insulating housing 10 has two first installing portions 108, like columns, extending downward from the lower face thereof for fixing the insulating housing 10 on a circuit board, in addition, the front side plate 1421 has a front fixing tail 1422 extending downward and the second side plate 142 has a rear fixing tail 1424 for fixing the outer shell 12 on the circuit board, thus, the whole board connector 100 can be firmly fixed to the circuit board.

Firstly, the second shell 14 is assembled to the insulating housing 10 from front to rear until a front end of the board portion 103 goes into a narrow groove formed by the lower plate 141 and the attachment plate 143, the first locking tabs 144 goes into and are received in the first locking grooves 104, and the through openings 145 are opposite to the second locking grooves 105. Secondly, the first shell 13 is assembled to the insulating housing 10 with the second shell 14 from rear to front until the rear plate 133 resists against the a rear end of the insulating housing 10 or a rear end of the second side plate 142, and the second locking tabs 1331 go through the through openings 145 and are received in the second locking grooves 105. Thirdly, the third locking tabs 1321 bend toward a lower of the insulating to go through the notches 1423 and be received in the third locking grooves 106. To facilitate assembling, a free end of the attachment plate 143 has a guiding face 1431.

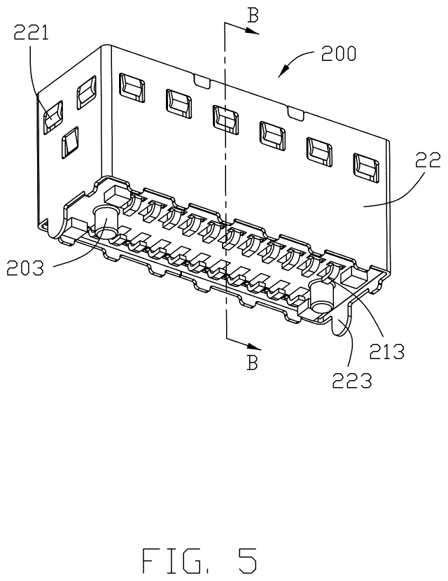

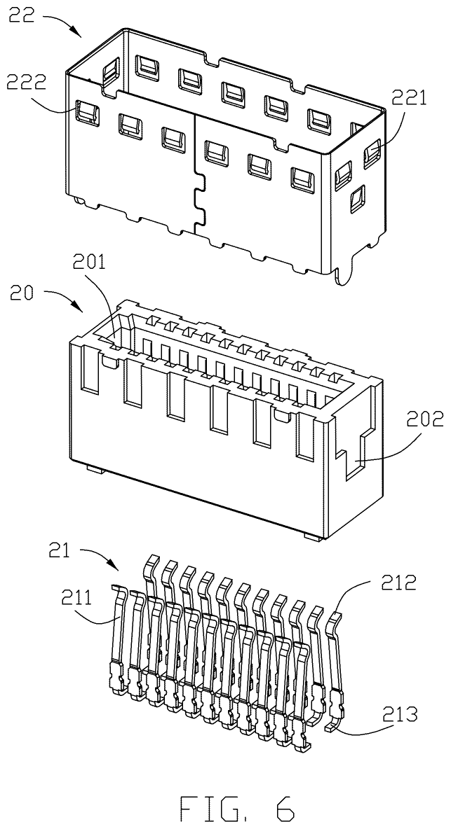

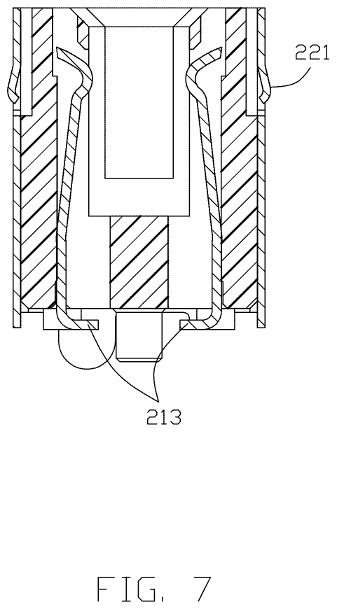

Referring to FIGS. 5-7, the mating connector 200 comprises an insulative housing 20, plural mating terminals 21 retained and received in the insulative housing 20 and an outer shielding shell 22 surrounding the insulative housing 20. The insulative housing 20 has two longitudinal walls and a mating slot 201 between the two longitudinal walls. The mating terminals 11 are rowed at each longitudinal wall and are at two opposite sides of the mating slot 201. The insulating housing has plural holding grooves 202 at peripheral faces thereof. The holding grooves 2020 are located around the insulative housing 20 and the shielding shell 22 has plural resisting tabs 221 received and locked in the corresponding holding grooves 202. The resisting tabs 221 are formed by tearing from the shielding shell 22. Each mating terminal 21 comprises a fixing portion 211 embedded in the insulative housing 20, an upper contacting portion 212 extending upwardly from the fixing portion 211 and protruding into the mating slot 201, and a lower contacting portion 213. The lower contacting portion 213 bends inwardly from the lower end of the fixing portion 211 first and then extends horizontally, so the free ends of the lower contacting portions 213 of the two rows that are opposite and extend toward each other to minimize an area of the circuit board occupied by the mating connector and prevent signal leakage during signal transmission. The insulative housing 20 has two second installing portions 203 extend downward from a lower face of the insulative housing 20. Preferably, the second installing portions 203 are columns. The shielding shell 22 has at least two fixing tails 223 for fixing on a circuit board. The resisting tabs 221 are tore from the shielding shell 22. A diagonal line of a notch 222 in which the resisting tabs 221 are received is less than 2 mm.

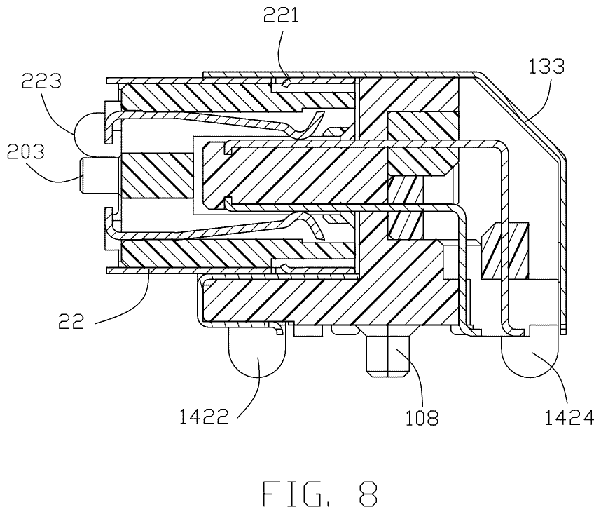

Referring to FIG. 8, an end of the mating connector 200 with the mating slot 201 is inserted into the mating cavity, the tongue portion 102 is inserted into and received in the mating slot 201 when the electrical connector 100 and the mating connector 200 get mated with each other, and the terminals 11 located at two sides of the tongue portion 102 get electrically connected with the mating terminals 21 located at two sides of the mating slot 201. To make the electrical connector 100 and the mating connector 200 mate tightly, some of the resisting tabs 221 electrically resist against an inner face of the upper plate 131 and some of the resisting tabs 221 electrically resist against an inner face of the lower plate 141.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing comprising a base portion and a tongue portion extending forward from the base portion;
plural terminals located at the tongue portion; and
an outer shell surrounding the insulating housing and comprising a first shell and a second shell discrete from each other;
wherein the first shell comprises an upper plate, two first side plates, and a rear plate spaced from the two first side plates, the second shell comprises a lower plate and two second side plates, the first shell and the second shell are assembled together to commonly surround the insulating housing for defining a mating cavity around the tongue portion, the upper plate and the lower plate are parallel to the tongue portion and located at two opposite sides of the tongue portion, and each of the second side plates spans forward to reach a corresponding first side plate and spans backward to reach the rear plate.

2. The electrical connector as claimed in claim 1, wherein the insulating housing comprises a board portion extending forward from the base portion and located below the tongue portion, the lower plate is attached to an upper face of the board portion, and the second shell comprises an attachment plate bending from a front edge of the lower plate toward a bottom of the board portion for making the lower plate firmly attached to the board portion.

3. The electrical connector as claimed in claim 2, wherein the first side plates are partially overlapped with corresponding second side plates along a front-rear direction in a way that the first side plates are tightly attached outside corresponding second side plates.

4. The electrical connector as claimed in claim 3, wherein the second shell comprises two front side plates bending downwards from opposite sides of the lower plate and are located in a same plane with corresponding second side plates.

5. The electrical connector as claimed in claim 1, wherein each of the second side plates has a first locking tab at an upper end thereof, the insulating housing has two first locking grooves, and the first locking tabs are received in corresponding first locking grooves.

6. The electrical connector as claimed in claim 1, wherein the rear plate has two second locking tabs bending forward from two side edges thereof respectively, each side wall of the base portion has a second locking groove, and the second locking tabs are received in corresponding second locking grooves by passing through an opening on the second side plate.

7. The electrical connector as claimed in claim 1, wherein each of the two first side plates has two third locking tabs bending inwardly from a lower edge thereof, a lower face of the insulating housing has plural third locking grooves, the third locking tabs are received in corresponding third locking grooves.

8. The electrical connector as claimed in claim 7, wherein both the lower edges of the front side plate and the second side plate have notches opening downward, the third locking tabs pass through the notches and are received in the third locking grooves.

9. A right angled electrical connector comprising:
an insulating housing comprising a base portion and a tongue portion extending forward from the base portion;
a row of terminals located at the tongue portion; and
a one-piece first shell and a one-piece second shell commonly surrounding the insulating housing to define a mating cavity in which the tongue portion extends;
wherein the first shell comprises an upper plate and two first side plates, the second shell comprises a lower plate, two front side plates bending downwards from the lower plate, and two rear side plates located behind the lower plate, and the first side plates overlap the front side plates and the rear side plates to wholly shield the insulating housing in a direction perpendicular to the first side plates.

10. The electrical connector as claimed in claim 9, wherein the insulating housing comprises a board portion extending forwards from the base portion, an attachment plate bends downwards and then rearwards from a front edge of the lower plate, and the attachment plate is fitly retained on the board portion.

11. The electrical connector as claimed in claim 10, wherein the first shell comprises a rear plate behind the base portion, the rear side plates shield gaps between the two first side plates and the rear plate respectively.

12. The electrical connector as claimed in claim 11, wherein each of the rear plate has a locking tab extending forward, a front end of the locking tab go through an opening defined on the rear side plate and into a groove defined on the insulating housing.

13. An electrical connector assembly comprising:
a male connector adapted for mounting on a printed circuit board, the male connector comprising:
an insulating housing comprising a base portion and a tongue portion extending forward from the base portion;
a plurality of terminals located at the tongue portion; and
a shielding shell surrounding the insulating housing and defining a mating cavity around the tongue portion with an inserting opening, the shielding shell wholly shielding the insulating housing except the inserting opening and a mounting face of the male connector; and
a female connector adapted for mating with the male connector;
wherein the shielding shell defines plural holes each having a diagonal dimension less than 2 mm.

14. The electrical connector assembly as claimed in claim 13, wherein the female connector comprises:
an insulative housing having a mating slot;
plural mating terminals exposed to the mating slot; and
a shielding shell wholly surrounding the insulative housing and having plural holes each having a diagonal dimension less than 2 mm.

15. The electrical connector assembly as claimed in claim 14, wherein the plural mating terminals comprise upper contacting portions exposed to the mating slot and lower contacting portions exposed to a lower of the insulative housing, and the lower contacting portions overlaps the upper contacting portions in a mating direction in which the male connector is inserted into the female connector.
